(19) United States
(12) Patent Application Publication
(10) Pub. No.: US 2017/0300953 A1
(43) Pub. Date: Oct. 19, 2017

(54) SYSTEM AND METHOD FOR INTEGRATED ACCUMULATION AND GRANTING OF BONUS IN ON-LINE COMMERCIAL TRANSACTION

(71) Applicant: Seong Kil KIM, Seoul (KR)

(72) Inventor: Seong Kil KIM, Seoul (KR)

(21) Appl. No.: 15/638,664

(22) Filed: Jun. 30, 2017

Related U.S. Application Data
(63) Continuation of application No. PCT/KR2015/011488, filed on Oct. 29, 2015.

(30) Foreign Application Priority Data
Dec. 31, 2014 (KR) 10-2014-0194910

(51) Int. Cl. G06Q 30/02; G06Q 20/06

(52) U.S. Cl. CPC G06Q 30/0226; G06Q 30/0239; G06Q 20/06; G06Q 30/0227; G06Q 30/0236

(57) ABSTRACT

The present invention relates to a system and a method of integrally accumulating and granting a bonus in an on-line commercial transaction, in which in order to integrally accumulate an accumulated point according to a wired/wireless on-line site commercial transaction, an Internet of communication (IoC)-bonus gateway automatically calculates various commercial transaction bonuses and transmits the calculated commercial transaction bonuses to a user terminal device, and the commercial transaction bonuses are transmitted from the user terminal device to a bonus server, so that the on-line commercial transaction bonus is granted, accumulated, and integrated, without passing through an on-line electronic payment granting intermediary gateway (payment gateway (P/G)).

### TECHNICAL FIELD

The present invention relates to a system and a method of integrally accumulating and granting a bonus in an on-line commercial transaction, in which in order to integrally accumulate an accumulated point according to a wired/wireless on-line site commercial transaction, an

Internet of communication (IoC)-bonus gateway automatically calculates various commercial transaction bonuses and transmits the calculated commercial transaction bonuses to a user terminal device, and the commercial transaction bonuses are transmitted from the user terminal device to a bonus server, so that the on-line commercial transaction bonus is granted, accumulated, and integrated, without passing through an on-line electronic payment granting intermediary gateway (payment gateway (P/G)).

### BACKGROUND ART

In the related art, for a real-time bonus service, such as a point, in an on-line commercial transaction, servers of most bonus companies need to be in a state of including an integrated bonus accumulation reference of an on-line site in advance, and professionally connecting a program or sharing user log information regularly with each of the on-line sites, mutually establishing and connecting an exchange system one-to-one with each of the on-line sites, or directly communicating or professionally connecting one-to-one with all of the P/Gs that are used by the respective on-line sites.

Further, in this state, there is a problem in that high maintenance cost is consumed and there is a limit in entering a market by the bonus offering company and expanding the market due to a complex constitution and maintenance system, in which a bonus (point) and the like need to be calculated and processed based on a payment granting confirmed amount received through the P/G and the like in real time. Further, there are many problems in an integrated bonus service among the bonus offering company and the on-line sites according to avoidance of affiliation by the on-line sites, use avoidance by users due to inconvenience, and the like.

In relation to this, Korean Patent Application Laid-Open No. 2003-0004795 (published on Jan. 15, 2003) discloses a technology for a system and a method of integrally managing a bonus point on-line.

### DETAILED DESCRIPTION OF THE INVENTION

### Technical Problem

Accordingly, an object of the present invention provides a system and a method of integrally accumulating and granting a bonus in an on-line commercial transaction utilizing a wired/wireless IoC-bonus gateway (B/G), in which by a concept of the Internet of communication (IoC) applying the Internet of Things (IoT), a bonus offering company does not directly interlock finally granted and confirmed data interacted through a bilateral communication network configured according to a necessity of bilateral granting and confirmation interaction with the bilateral communication network, but directly and automatically identifies final granting or confirmation result data at an arrival point of the final granting or confirmation result data to generate data of a new third value and accomplish Internet information by the generation of the new third value data.

### Technical Solution

In order to achieve the object, a system for accumulating and granting an on-line commercial transaction bonus according to the present invention includes: a final payment granted data database (DB) which receives final payment granted data from an on-line payment granting intermediary gateway (P/G) and autonomously stores the received payment granted data in an on-line site; an Internet of communication (IoC)-bonus gateway (B/G) which automatically calculates a bonus based on the final payment granted data received from the final payment granted data DB of the on-line site and an autonomously embedded pre-set reference of the on-line site in a state of being applied into the on-line site, and stores the calculated bonus, and identifies a user; a bonus server processing confirmation and granting of the bonus data; and a user terminal device which receives calculated bonus data from the IoC-B/G; and a communication interface device which receives an agreement request for a benefit of the bonus data received from the user terminal device and interacts with the bonus server, confirms and grants bonus providing on-line site information from the bonus server and normal bonus data, and transmits a result of the interaction to the user terminal device as a granting result.

Further, in order to achieve the object, a method of integrally accumulating and granting an on-line commercial transaction bonus, which uses a system for accumulating and granting an on-line commercial transaction bonus including a final payment granted data database (DB) of an on-line site, an IoC-bonus gateway (B/G), a user terminal device, a communication interface module, a communication interface device, and a bonus server, includes: receiving, by the on-line site, final payment granted data from the P/G or autonomously confirming a receipt, such as a cash receipt and an Internet banking receipt, and storing the final payment granted data in the final payment granted data DB; performing, by the final payment granted data DB, professional transception-interlocking with the on-line site and transmitting the final payment granted data to the IoC-B/G; receiving, by the IoC-B/G, the payment granted data from the final payment granted data DB; determining, by the IoC-B/G, the kind of bonus for the received payment granted data, and calculating bonus data based on a pre-set reference and storing the calculated bonus data; interacting, by the IoC-B/G, the user identified bonus data through a communication protocol, and directly interacting with the bonus server or communicating and interacting with the user terminal device in real time; receiving, by the user terminal device, the calculated bonus data from the IoC-B/G, and then executing, by a user, a confirmation and accumulation granting request; receiving, by the communication interface device, the accumulation and granting request of the bonus data transmitted through a bonus offering company non-dedicated messenger application or a short message service (SMS)/multimedia messaging service (MMS) from the user terminal device and simultaneously interacting with the bonus server; and interacting, by the bonus server, the bonus data and accumulating and granting the bonus.

Furthermore, in order to achieve the object, there is provided a processor readable recording medium, in which a program for executing the method in a processor is recorded.

### Advantageous Effects

According to the present invention, there are not required equipment, and maintenance costs and procedures according to a regular professional connection or user log information sharing between a bonus offering company and on-line sites, one-to-one mutual establishment of and connection to an exchange system, and an establishment and a management of a wired/wireless Internet communication network with each of payment gateway (P/G) companies, so that a cost saving effect is considerable. Further, in a position of the bonus offering company, usage charges, which occupy a considerable portion of raw cost, with the P/G companies and the like are not required, so that effects in decreasing raw cost and improving profitability are noticeably large.

Further, since most of the difficulties in affiliation of the on-line sites with the bonus offering company are removed, affiliations between the bonus offering company and the on-line sites become very convenient and simple, so that it is possible to greatly expand a size of an on-line site participating in an integrated bonus accumulating service and enable the on-line sites to efficiently perform marketing with low costs, thereby greatly achieving effects in expanding the present invention to more on-line sites and increasing users and user benefits.

### BRIEF DESCRIPTION OF DRAWINGS

FIG. 1 is a block diagram illustrating a configuration of a system for integrally accumulating and granting an on-line (on-line and mobile) commercial transaction bonus according to an exemplary embodiment of the present invention.

FIG. 2 is a block diagram illustrating a detailed configuration of an IoC bonus gateway (B/G) of FIG. 1.

FIG. 3 is a flowchart illustrating a method of integrally accumulating and granting a bonus by using the system for integrally accumulating and granting an on-line commercial transaction bonus of FIG. 1.

FIG. 4 is a flowchart illustrating a detailed operation process of the IoC-bonus gateway (B/G) of FIG. 1.

### BEST MODE

Advantages and features of the present invention and methods of achieving the advantages and features will be clear with reference to exemplary embodiments described in detail below together with the accompanying drawings. However, the present invention is not limited to the exemplary embodiments set forth below, and may be embodied in various other forms. The present exemplary embodiments are for rendering the description of the present invention complete and are set forth to provide a complete understanding of the scope of the invention to a person with ordinary skill in the technical field to which the present invention pertains, and the present invention will only be defined by the scope of the claims. In the following description of the exemplary embodiment, a detailed description of known configurations or functions will be omitted when it is determined that the detailed description may unnecessarily make the subject matter of the present invention unclear. The terms which will be described below are terms defined in consideration of the functions in the exemplary embodiment of the present invention, and may be different according to users, intentions of the users, or customs. Therefore, the definitions should be made based on the entire contents of the present specification.

In a system and a method of integrally accumulating and granting a bonus according to the present invention, in order for one user to integrally accumulate an accumulated point according to a commercial transaction during the plurality of wired/wireless on-line (mobile and on-line) site commercial transactions, particularly, in a state where an IoC bonus gateway based on Internet of communication (IoC) applying Internet of Things (IoT) is applied into each on-line site, a bonus accumulating company autonomously automatically first calculates various commercial transaction bonuses into bonuses of different types and values based on different payment amounts and payment methods, and the like, and the calculated bonus is transmitted to a user terminal device and is directly transmitted by a user to a bonus server through a multiplex communication interface device, so that the on-line commercial transaction bonus is granted, accumulated, and integrated, without passing through an on-line electronic payment granting intermediary payment gateway (P/G) which on-line sites are currently using, without using the manner in the related art in which the bonus offering company needs to one-to-one professionally connect a program one to one or share and exchange user log information through one-to-one wired/wireless Internet communication with respective on-line sites throughout the payment, and in a reverse direction of the manner in the related art in which commercial transaction data is finally received by the bonus offering company and then a bonus is calculated, granted, and replied.

That is, in a state where the IoC-B/G includes a bonus accumulation reference of an affiliated on-line site and is installed and applied into the affiliated on-line site, in order for the on-line site to receive a payment when a user makes a payment in the affiliated on-line site, the IoC-B/G may receive final payment granted data from a final payment granted data database (DB) autonomously storing the final payment granted data after a payment completion through a currently connected Internet payment granting intermediary P/G, and automatically calculate a bonus, such as a point, a mileage, an electronic coupon, an electronic stamp, and an electronic gift coupon, or may first generate a pre-designated bonus without a calculation function.

Accordingly, the user may generate a bonus after the current payment for the calculated and generated bonus, or may directly communicate and interact an agreement and a granting request with a server of the bonus offering company by an Internet communication interaction through an

Internal communication protocol between the IoC-B/G and the server of the bonus offering company in an on-line site in which the currently authenticated user stays.

In another method, the bonus calculated and generated by the IoC-B/G is transmitted to a user terminal device, and the user directly transmits a bonus agreement and granting request to the server of the bonus offering company through a multiplex communication interface device by using his/her user terminal device, so that the bonus may be granted, accumulated, and integrated.

In a state where any one method is designated and selected or both the methods are applied, any one method in a next order may be automatically selected according to a selection by the user or the affiliated on-line site or a system environment, that is, when a preferentially applied method is not normally processed in a state where the preferentially applied method is sequentially pre-set.

Hereinafter, an exemplary embodiment of the present invention will be described in detail with reference to the accompanying drawings.

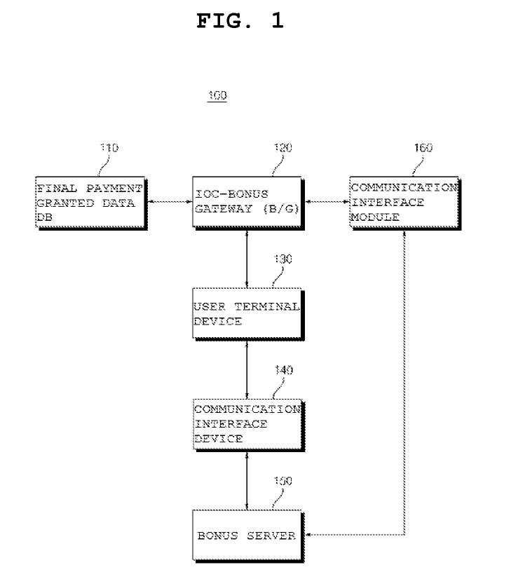

FIG. 1 is a block diagram illustrating a configuration of a system 100 for integrally accumulating and granting an on-line commercial transaction bonus according to an exemplary embodiment of the present invention.

Referring to FIG. 1, the system 100 for integrally accumulating and granting an on-line commercial transaction bonus may include a final payment granted data database (DB) 110 of an on-line site, an IoC-bonus gateway (B/G) 120, a user terminal device 130, a communication interface device 140, a bonus server 150, a communication interface module 160, and the like.

The final payment granted data DB 110 receives payment granted data for a product or a service from a payment gateway (P/G) (not illustrated) which on-line sites, such as all of the sites including a shopping mall, in which a commercial transaction is generated, and public institution service sites use for a payment receipt and the like, and stores the received payment granted data. However, this case includes the case where the on-line site autonomously confirms an internal payment receipt, such as cash, an account transfer, and an Internet banking payment receipt and stores the confirmed internal payment receipt therein, in addition to an electronic payment including a credit card payment through the P/G, and the final payment granted data DB 110 stores the received or and internally confirmed and stored final payment granted data and simultaneously transmits the received or internally confirmed and stored final payment granted data to the IoC-B/G 120.

The IoC-B/G 120 receives the final payment granted data from the final payment granted data DB 110, and automatically calculates or generates a bonus and a notice content, such as a point, a mileage, an electronic coupon, an electronic stamp, an electronic lottery ticket, and a notice based on an autonomously embedded pre-set reference of the affiliated on-line site for the received final payment granted data. When the user recognizes the content in the on-line site, in which the user presently stays for confirming a bonus accumulation after making a payment, and agrees to the bonus and requests a granting, the bonus calculated or generated by the IoC-B/G 120 may be transmitted to and interacted with the bonus server 150 through the communication interface module 160 formed of a communication protocol, such as an transmission control protocol-Internet protocol (TCP-IP) in real time and may be aggregated and calculated as a bonus of the corresponding user.

However, when a service and a system environment between the bonus offering company and the on-line site are not appropriate to the execution of the operation, the method may be selected by the user, or an exemplary embodiment below may also be automatically selected and executed for a method, in which in a state where a preferentially applied method is sequentially set in advance, when the preferentially applied method is not normally processed and has an error, another method in a next order is automatically selectable.

The IoC-B/G 120 calculates or generates the bonus, and simultaneously transmits the calculated or generated bonus to the user terminal device 130, for example, a smart phone, a smart pad, and a personal digital assistant (PDA), through a wireless Internet application dedicated to the bonus server 150, that is, a bonus offering company dedicated Internet application exclusively used between the IoC-B/G 120 and the bonus offering company, in which the bonus server 150 is positioned, and a non-dedicated general Internet messenger application, for example, Kakao Talk and line, and a transmission of a short message service (SMS) or multimedia message service (MMS) that is a mobile communication messenger service, and the user receiving the calculated or generated bonus through the user terminal device recognizes the contents and simultaneously requests an accumulation and a granting of the bonus.

In this case, in regard to a request path, when the method of the transmission of the calculated or generated bonus to the user terminal device is the method through the bonus offering company dedicated wireless Internet application, the user requests the accumulation and the granting of the bonus to the bonus server 150 through the autonomous interaction, and when the method of the transmission of the calculated or generated bonus to the user terminal device is the method through the non-dedicated Internet messenger application, the SMS, or the MMS, the user requests the accumulation and the granting of the bonus to the bonus server 150 via the communication interface device 140 of the bonus offering company.

Further, in the state where the IoC-B/G 120 is connected and applied to the on-line site as a bilaterally communication gateway (G/W) utilizing a communication protocol, the IoC-B/G 120 may directly perform the communication and interaction with the on-line site and the bonus server or perform an interaction with the user terminal device for the autonomously calculated and stored bonus data, and identify whether the user joins the bonus offering company in the on-line site which the user currently uses.

The communication interface device 140 is a simultaneous multiple communication interface terminal device between the user terminal device 130 and the bonus server 150. The communication interface device 140 receives the request for the bonus data accumulation and granting of the user received from the user terminal device 130, transmits the received request to the bonus server 150, receives bonus offering affiliated on-line site information and a result of authentication and granting of normal bonus data, and transmits the granting result to the user terminal device 130 again. Further, the communication interface device 140 bilaterally interacts with one or more of a messenger of an interaction available wireless Internet messenger application, and the SMS and MMS mobile communication messengers during the interaction with the user terminal device 130.

The bonus server 150 processes the authentication, the collection, and the calculation of thee received bonus data and processes the web and wireless Internet application service, and the like, and simultaneously returns the result by the same transmission method and path as the method and path through which the bonus data is transmitted to the bonus server to the user again. Through the process, the bonus server 150 integrates and collects the bonuses of the same type and in the same unit which one user accumulates in the plurality of on-line sites. In this case, in the integration of the bonus, the bonuses generated through the IoC-B/G in two or more on-line sites registered in the bonus server 150 or some on-line sites among them are integrated in the unit of each user.

Further, the operation of calculating, by the IoC-B/G 120, the bonus itself is omitted, and the bonus server 150 may receive the final payment granted data received by the final payment granted data DB 110 of the on-line site as it is by the same method as the foregoing interaction methods and then calculate a bonus according to a bonus calculation reference for each affiliated on-line site pre-stored in the bonus server.

For example, when a bonus calculation reference pre-stored in the database DB of the bonus server 150 is that the kind of bonus of on-line site A is a point and a point calculation reference is 5% of a payment amount, and a final payment amount of a user of on-line site A received from the user terminal device 130 is 50,000 KRW, the bonus server 150 calculates 2,500 points that is 5% of 50,000 KRW as a point and replies the calculated points to the user.

For another example, when a bonus calculation reference pre-stored in the database of the bonus server 150 is that the kind of bonus of on-line site B is an electronic stamp and an electronic stamp calculation reference is that the number of electronic stamps is one when a payment amount is less than 20,000 KRW and the number of electronic stamps is two when a payment amount is 20,000 KRW or more, and a final payment amount of a user of on-line site B received from the user terminal device 130 is 30,000 KRW, the bonus server 150 calculates two electronic stamps and replies the calculated stamps to the user.

Further, the communication interface module 160 communicates through a communication protocol TCP/IP which implements communication interaction between the IoC-B/G 120 and the bonus server 150, and the like.

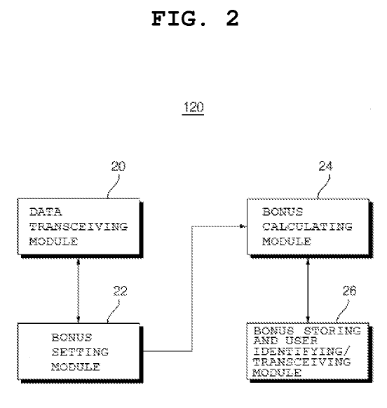

FIG. 2 is a block diagram illustrating a detailed configuration of the IoC (B/G) 120 of FIG. 1.

Referring to FIG. 2, the IoC-B/G 120 may include a data transceiving unit 20, a bonus setting module 22, a bonus calculating module 24, a bonus storing and user identifying/transceiving module 26, and the like.

The data transceiving module 20 is professionally connected with the final payment granted data DB 110 inside the on-line site to receive final payment granting and confirmation data (for example, a payment amount, a payment means, a payment business branch, payment date and time, other unique classification information, and the like), such as final payment granting completion of a credit card or cash receipt confirmation. The data transceiving module 20 sequentially or simultaneously transmits the received final payment granted data to the bonus setting module 22 and the bonus calculation module 24.

The bonus setting module 22 may make one or two or more kinds of the bonuses among various kinds of bonuses, for example, a point, a mileage, an electronic coupon, an electronic stamp, a quiz, a lottery, an event, and other types of gift coupon, set in the bonus calculating module 24 be simultaneously applied according to the final payment granted data received from the data transceiving module 20 and a pre-set bonus kind application reference in the state where various bonus kind application references are set in advance.

For example, the bonus setting module 22 may set a reference of an application of the kind of bonus so that the corresponding bonus is calculated by the bonus calculating module 24 by applying only one kind of bonus including a point when a payment amount is less than 50,000 KRW, and applying two kinds of bonuses including a point and an electronic coupon when a payment amount is 50,000 KRW or more.

In this case, the reference, in which one kind or two or more kinds of bonuses are simultaneously applied, is the kind of payment means, such as a credit card, cash, and an electronic money, other than the final payment amount like the foregoing example, and for example, when a payment means cash, one kind of bonus including a point may be applied, and when a payment means a credit card, two kinds of bonuses including a point and an electronic coupon may be applied. Further, the reference is a class classification of a user and the like, and for example, one kind of bonus including a point may be applied to a user divided as a general user and two kinds of bonuses including the point and the electronic coupon may be applied to a user classified as an excellent user.

Further, the reference is a size of a bonus treatment of an affiliated on-line site, and for example, when the number of bonus treatments for the previous month is less than 100, one kind of bonus including a point may be applied, and when the number of bonus treatments for the previous month is 100 or more, two kinds of bonuses including a point and an electronic coupon may be applied. Further, the reference is a bonus treatment time or order, and for example, when a bonus treatment time is the morning or a bonus treatment order is earlier than the tenth order of the day, only one kind of bonus including a point may be applied, and when a bonus treatment time is the afternoon and a bonus treatment order is the tenth order or later of the day, two kinds of bonuses including a point and an electronic coupon may be applied, and one kind of other various bonus kind application references may be applied or other various bonus kind application references may also be combined and applied.

Further, the bonus setting module 22 may selectively apply or may not apply the bonus according to a need to provide a customized integrated bonus for a flexible marketing of the bonus offering company or the affiliated on-line site.

The bonus calculating module 24 automatically calculates one or more kinds of bonuses pre-set by the bonus setting module 22 according to the final payment granted data (for example, the payment amount) received from the data transceiving module 20 and a pre-set calculation reference of each corresponding bonus in the state where all kinds of bonuses applicable by the on-line sites and the calculation reference of the bonus are preset. In this case, bonus data may be set to be separately calculated according to the final payment granted data or a pre-set bonus may be set to be equally generated only with a fact of the final payment confirmation.

Further, the bonus calculating module 24 may be selectively applied such that regardless of the method, only the final payment granted data is transmitted to the bonus storing and user identifying/transceiving module 26 without using the bonus calculating module 24. That is, the final payment granted data may be directly transmitted to the bonus storing and user identifying/transceiving module 26 without utilizing all of the functions of the bonus setting module 22 or the bonus calculating module 24, so that the same bonus for each reference may be calculated according to the reference preset in the bonus setting module 22.

Further, the bonus storing and user identifying/transceiving module 26 may store the bonus data automatically calculated in the bonus calculating module 24, and then may directly perform real-time communication and interaction with the bonus server 150 through the application of the communication protocol, for example, the TCP-IP. The bonus data may be transmitted to the user terminal device 130 by using the wireless Internet application dedicated to the bonus server 150, the bonus offering company non-dedicated messenger application, such as Kakao Talk and line, or the SMS and the MMS that are the mobile communication messengers, through a connection setting of a mobile communication messenger transmitting unit within the bonus storing and user identifying/transceiving module 26 itself or of the affiliated on-line site, and then the user may directly request the accumulation of the bonus from the bonus offering company. Further, the bonus storing and user identifying/transceiving module 26 may perform a transmission of the bonus data, an inquiry of non-transmitted details, and a re-transmission of a non-transmitted bonus. In this case, the bonus storing and user identifying/transceiving module 26 may transmit the bonus offering company dedicated wireless Internet application, in addition to the bonus data, by setting a function of enabling the bonus offering company dedicated wireless Internet application to be transmitted together to the user terminal device 130.

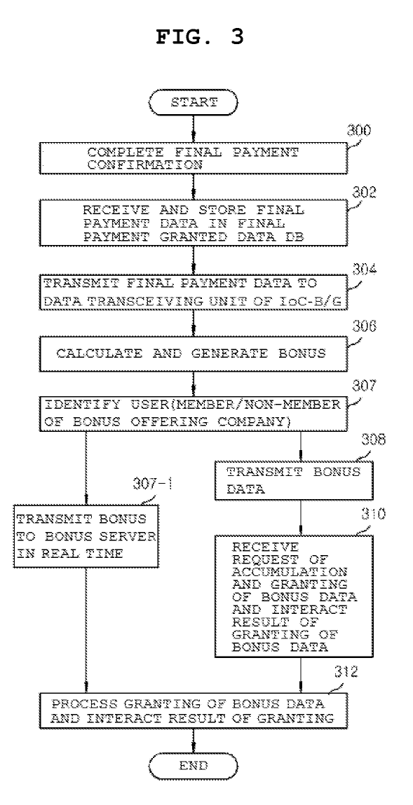

FIG. 3 is a flowchart illustrating a method of accumulating and granting a bonus by using the system 110 for integrally accumulating and granting an on-line commercial transaction bonus of FIG. 1.

Hereinafter, a method of accumulating, granting, and integrating an on-line commercial transaction bonus according to an exemplary embodiment of the present invention will be described in detail with reference to FIG. 3.

The method of accumulating, granting, and integrating an on-line commercial transaction bonus according to the exemplary embodiment of the present invention does not professionally interlock or share log information regularly throughout a payment between a bonus offering company and affiliated on-line sites and mutually establish and connects an exchange system one-to-one, or does not pass through the Internet electronic payment granting intermediary gateway (payment gateway (P/G (not illustrated)). Further, it is presumed that the case where the on-line site passes through and uses the P/G for a payment and a payment confirmation is for the purpose of simply receiving a payment from a user before a bonus is related.

First, when a final payment granting of a credit card or a final payment, such as cash, an account transfer, and an Internet banking payment of the on-line site itself, is completely confirmed through the P/G executed in an on-line site (operation 300), final payment granted data is received and stored in the final payment granted data DB 110 of the on-line site itself (operation 302) and simultaneously is transmitted to the data transceiving unit 20 of the IoC-B/G 120 (operation 304). A bonus, such as a point, a mileage, an electronic coupon, an electronic stamp, and an electronic lottery, is calculated or generated for the received final payment granted data based on an affiliated on-line site bonus calculation reference pre-set in the bonus setting module 22 and the bonus calculating module 24 of the IoC-B/G 120 (operation 306).

After the bonus data is calculated or generated, a user is identified, that is, whether a user joins the bonus offering company is identified, in the on-line site in which a user stays for a confirmation of a bonus accumulation after the payment by the autonomous bonus storing and user identifying/transceiving module 26 or through a connection with a bonus offering company member and non-member identifying unit within the affiliated on-line site, and for example, when the user is a member of the bonus offering company, a member unique identification information, such as an ID or a password of the bonus offering company, or a unique card number, is completely registered, and when the user is not a member of the bonus offering company, one or two or more elements of non-member unique identification information, such as a smart phone number, a birth date, and an e-mail address, through which a user identify may be authenticated during a later joining authentication, is completely registered (operation 307).

In this case, even when the user is identified as the non-member, as well as the member of the bonus offering company in operation 307, the calculated or generated bonus data may be transmitted and processed by the same manner in all of the four methods of finally transmitting and processing the bonus data to the bonus server 150 together with the member and non-member identification information.

Next, the bonus data is transmitted to the bonus server 150 in real-time which interacts and is connected with the bonus storing and user identifying/transceiving module 26 of the IoC-B/G 120 in real time through a TCP/IP that is an Internet communication protocol (operation 307-1), and an authentication of the member or the non-member is performed, the bonus data granted and confirmed with the pre-set agreement and contract contents of the on-line site is authenticated, collected, and calculated, and web and application services are processed (operation 312).

However, when it is not appropriate to apply the foregoing operation between the affiliated on-line site and the bonus offering company or it is decided that the foregoing method is not used according to selections of the affiliated on-line site and the bonus offering company, the foregoing methods are combined but the method is selected by the user, or when a backup system preparing a system error is desired to be applied, an exemplary embodiment below may be additionally combined and designated and selected, or may be sequentially automatically selected and executed.

The wired/wireless IoC-B/G 120 calculates and generates a bonus and simultaneously transmits the bonus data to the user terminal device 130 through a wireless

Internet application dedicated to the bonus server 150, a bonus offering company non-dedicated wireless Internet messenger application, such as Kakao Talk and Line, or the SMS and the MMS that are the mobile communication wireless messenger transmission networks (operation 308).

Next, when the bonus data is transmitted to and received in the user terminal device 130 through the wireless Internet application dedicated to the bonus server 150, a real-time interaction with the bonus server 150 is directly executed when the user receiving the bonus data agrees to the bonus and requests the accumulation of the bonus in the wireless Internet application. When the bonus data is transmitted to and received in the user terminal device 130 through the two methods including the reception of a message of the bonus offering company non-dedicated wireless Internet, or the reception of the SMS and the MMS that are the mobile communication wireless message transmission networks, and the user receiving the bonus data agrees to the bonus and requests the accumulation of the bonus through the bonus offering company non-dedicated wireless Internet messenger or the SMS and the MMS, the bonus data is simultaneously interacted with the bonus server 150 through the communication interface device 140, and the bonus server 150 confirms and grants affiliated on-line site information and normal bonus data and transmits a result of the confirmation and the granting interacted to the user terminal device 130 through the communication interface device 140 again to perform the interaction with the user terminal device 130 (operation 310).

The bonus server 150 authenticates, grants, collects, calculates, and stores the bonus data, processes web and application services, and the like, and simultaneously interacts the result of the processing to the user terminal device 130 through the communication interface device 140 by a direct interaction method in the bonus offering company dedicated wireless Internet application or the interaction with the communication interface device 140 after receiving the bonus data and the like (operation 312).

Further, when the bonus data of the non-member of the bonus offering company is granted, accumulated, and stored according to the method and the orders, and then the non-member is authenticated for joining later, the bonus accumulated, granted, and stored before joining may be automatically transferred and collected as a bonus of a joining authenticated member during a confirmation and authentication of the member through an automatic confirmation and authentication of the non-member user identification information when the member is authenticated. Further, the bonus server 150 may directly interact the granting result with the user terminal device 130 according to a necessity and a selection of the bonus offering company with an omission of the interaction with the communication interface device 140.

Further, as a use result through the respective operations and the device through the IoC-B/G, even when one user accumulates various kinds of bonuses in various on-line sites, all of the bonuses of the user are integrated. For example, when user A uses various on-line sites, that is, on-line sites B, C, and D, and then a bonus accumulated in on-line site B is two electronic stamps, and the bonuses accumulated in on-line sites C and D are 5,000 point and 10,000 points, respectively, as a point, the bonus of user A is the two electronic stamps and 15,000 points, and the accumulated bonus may be used in an exchange and compatible scheme in any of the affiliated on-line sites of the bonus offering company to achieve a bonus integration.

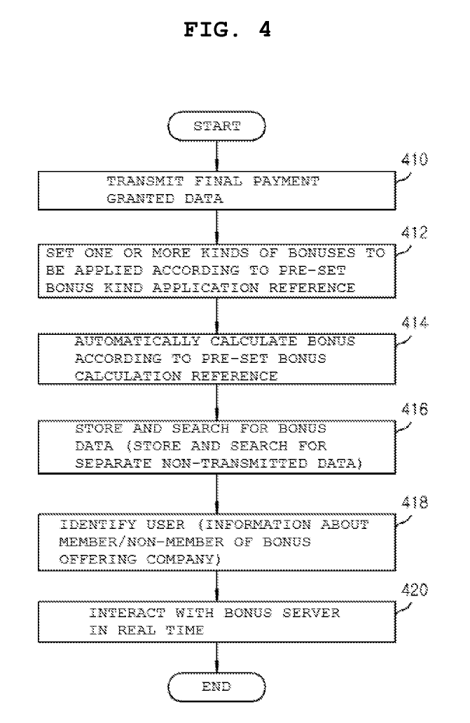

FIG. 4 is a flowchart illustrating a detailed operation process of the IoC-B/G 120 of FIG. 1.

Hereinafter, the detailed operation process of the IoC-B/G 120 of FIG. 1 will be described in detail with reference to FIG. 4.

First, the data transceiving module 20 is professionally connected with the final payment granted data DB 110, receives final payment granted data (for example, a payment amount, a payment means, an on-line site in which the payment is made, a payment date and time, and other unique discrimination information), such as a completion of a final payment confirmation of a credit card or a cash receipt confirmation, and sequentially or simultaneously transmits the received final payment granted data to the bonus setting module 22 and the bonus calculating module 24 (operation 410).

Next, in a state where various bonus kind application references are set in advance, the bonus setting module 22 sets one or two or more kinds of bonuses among various kinds of bonuses, for example, a point, a mileage, an electronic coupon, an electronic stamp, a quiz, a lottery, an event, or other types of gift coupons, set in the bonus calculating module 24 according to the final payment granted data received from the data transceiving module 20 and a pre-set bonus kind application reference to be simultaneously applied (operation 412).

In this case, the bonus setting unit 22 may set a reference of an application of the kind of bonus so that when a payment amount is less than 50,000 KRW, only one kind of bonus including a point is applied, and when a payment amount is 50,000 KRW or more, two kinds of bonuses including a point and an electronic coupon are applied, so that the bonus calculating unit 24 may calculate one or two or more corresponding kinds of bonuses for one commercial transaction. Further, the bonus setting unit 22 may apply or may not the entirety or a part of the function optionally according to a need to provide a customized integrated bonus for a flexible marketing of the bonus offering company or the affiliated on-line site.

For example, the bonus setting module 22 may set a reference of an application of the kind of bonus so that when a payment amount is less than 50,000 KRW, only one kind of bonus including a point is applied, and when a payment amount is 50,000 KRW or more, two kinds of bonuses including a point and an electronic coupon are applied, so that the corresponding bonus may be calculated in the bonus calculating unit 24. In this case, the reference, in which one kind or two or more kinds of bonuses are simultaneously applied, is the kind of payment means, such as a credit card, cash, and an electronic money, other than the final payment amount like the foregoing example, and for example, when a payment means cash, one kind of bonus including a point may be applied, and when a payment means a credit card, two kinds of bonuses including a point and an electronic coupon may be applied, and the reference is a class classification of a user and the like, and for example, one kind of bonus including a point may be applied to a user divided as a general user and two kinds of bonuses including the point and the electronic coupon may be applied to a user classified as an excellent user.

Further, the reference is a size of a bonus treatment of an affiliated on-line site, and for example, when the number of bonus treatments for the previous month is less than 100, one kind of bonus including a point may be applied, and when the number of bonus treatments for the previous month is 100 or more, two kinds of bonuses including a point and an electronic coupon may be applied, and the reference is a bonus treatment time or order, and for example, when a bonus treatment time is the morning or a bonus treatment order is earlier than the tenth order of the day, one kind of bonus including a point may be applied, and when a bonus treatment time is the afternoon and a bonus treatment order is the tenth order or later of the day, two kinds of bonuses including a point and an electronic coupon may be applied, and one kind of other various bonus kind application references may be applied or other various bonus kind application references may also be combined and applied. Further, the bonus setting module 22 may selectively apply or may not apply the bonus according to a need to provide a customized integrated bonus for a flexible marketing of the bonus offering company or the affiliated on-line site.

Further, in the state where all kinds of bonuses and bonus calculation references applicable by the affiliated on-line sites are set in advance, the bonus calculating module 24 automatically calculates one or more bonuses pre-set in the bonus setting module 22 according to the final payment granted data (for example, the payment amount) received from the data transceiving module 20 and the pre-set calculation reference of each corresponding bonus (operation 414). In this case, bonus data may be set to be separately calculated according to the final payment granted data or a pre-set bonus may be set to be equally generated only with a fact of the final payment confirmation. Further, the bonus calculating module 24 may be selectively applied such that regardless of the method, only the final payment granted data is transmitted to the bonus storing and user identifying/transceiving module 26 without using the bonus calculating module 24. That is, the final payment granted data may be directly transmitted to the bonus storing and user identifying/transceiving module 26 without utilizing all of the functions of the bonus setting module 22 or the bonus calculating module 24, so that the same bonus for each reference may be calculated according to the reference preset in the bonus setting module 22.

Next the bonus storing and user identifying/transceiving module 26 stores the bonus data automatically calculated in the bonus calculating module 24 in a storing unit (operation 416), and a separate non-transmitted data storing unit within the storing unit may separately stores and re-transmits only the non-transmitted data, and a term and a capacity of the storage may be set in consideration of a storage capacity. Further, the bonus storing and user identifying/transceiving module 26 includes a user bonus offering company member and non-member identifying unit and a transceiving unit to perform corresponding operations below.

After the bonus data is automatically calculated and stored, when the user recognizes the content in the on-line site, in which the user presently stays for confirming a bonus accumulation after making a payment, and agrees to the bonus and requests a granting, the user bonus offering company member and non-member identifying unit registers user identification information, for example, unique member identifying information, such as an ID of the bonus offering company, a password, or a unique card number, and when the user does not join the bonus offering company, the user bonus offering company member and non-member identifying unit completely registers one or two or more elements of non-member unique identification information, such as a smart phone number, a birth date, and an e-mail address, through which a user identify may be authenticated during a later joining authentication (operation 418).

In this case, even when the user is identified as the non-member, as well as the member of the bonus offering company in operation 418, the calculated or generated bonus data may be transmitted and processed by the same method as the methods below of finally transmitting and processing the bonus data to the bonus server 150 together with the member and non-member identification information.

Next, the transceiving unit within the IoC-B/G 120 includes two types that include an Internet communication module adopting a communication protocol, such as a TCP-IP, which may directly interact with the bonus server 150 through the wired/wireless Internet, and a mobile communication transmission module transmitting data to the user terminal device and transceives the data according to a selected method.

First, when the transceiving unit interacts through the Internet communication module, the transceiving unit directly interacts with the bonus server 150 which is interacted and connected with the bonus storing and user identifying/transceiving module 26 of the IoC-B/G 120 in real time through the TCP-IP that is the communication protocol and the like in real time (operation 420).

However, when a service and system environment between the bonus offering company and the on-line site is not suitable for the application of the foregoing operation or it is decided that the foregoing method is not used according to selections of the affiliated on-line site and the bonus offering company, the foregoing methods are combined according to a selection of a user, or a backup system preparing a system error is desired to be applied, one kind of method of directly interacting with the bonus server 150 in real time and the method through the mobile communication transmission module below may be executed, or both the method of directly interacting with the bonus server 150 in real time and the method through the mobile communication transmission module below are combined and used, so that any one between the two methods may be designated and selected or sequentially automatically selected and executed.

The mobile communication transmission module in the transmitting unit within the bonus storing and user identifying/transceiving module 26 may transmit the bonus data by a method of transmitting the bonus data to the user terminal device 130 through professional connection of an automatic connection to a transmission module of a wireless Internet application dedicated to the bonus server 150 or an internal module of the on-line site including a separate transmission module, a method of transmitting the bonus data to the user terminal device 130 through professional connection of an automatic connection to a transmission module of a bonus offering company non-dedicated wireless Internet messenger application, such as Kakao Talk and Line, or an internal module of the on-line site including a separate transmission module, a method of transmitting the bonus data to the user terminal device 130 through professional connection of an automatic connection to a transmission module of the SMS and the MMS that are the mobile communication wireless message transmission networks, or an internal module of the on-line site including a transmission module, and the like.

When the data is transmitted through the mobile communication transmission module, one or more methods among the three methods using the mobile communication transmission may be sequentially or automatically selected. That is, in a state where a preferentially applied method is sequentially set in advance, when the preferentially applied method fails to be normally processed, such as a transmission failure or a reception failure, another method of a next order may be automatically selected.

In this case, in all of the methods of directly interacting with the bonus server 150 in real time, the method of transmitting the bonus data to the user terminal device 130 through the professional connection of the automatic connection to the internal module of the on-line site, the method of transmitting the bonus data to the user terminal device 130 through the professional connection of the automatic connection to the internal module of the on-line side, and the bonus data may be transmitted by setting a function of transmitting the bonus offering company dedicated wireless Internet application and the like other than the bonus data to the user terminal device 130.

In the meantime each block of the accompanying block diagrams and the combinations of the operations of the flowchart may also be performed by computer program instructions. The computer program instructions may be mounted in a processor of a general purpose computer, a specialized computer, or other programmable data processing equipment, and the instructions performed through the processor of the computer or other programmable data processing equipment generate means performing the functions described in the blocks of the block diagram and the operations of the flowcharts. In order to implement a function by a specific method, the computer program instructions may be stored in a computer usable or readable memory aiming the computer or other programmable data processing equipment, so that the instructions stored in the computer usable or readable memory may also produce a manufactured item including an instruction means performing the function described in each block of the block diagram and each operation of the flowchart. The computer program instructions may be installed in the computer or other programmable data processing equipment, so that the instructions, which generate the process in which a series of operations is performed in the computer or other programmable data processing equipment and is executed by the computer, and are performed in the computer or other programmable data processing equipment, may also provide operations for executing functions described in each block of the block diagram and each operation of the flowchart.

In addition, preferred embodiments of the present invention have been illustrated and described above, but the present invention is not limited to the above-described specific embodiment, it is obvious that various modifications may be made by those skilled in the art, to which the present invention pertains without departing from the gist of the present invention, which is claimed in the claims, and such modified embodiments should not be individually understood from the technical spirit or prospect of the present invention.

### INDUSTRIAL APPLICABILITY

The present invention may be used in a system for integrally managing an accumulated point according to a wired/wireless on-line site commercial transaction.

1. A system for accumulating and granting an on-line commercial transaction bonus, the system comprising:
a final payment granted data database (DB) which receives final payment granted data from an on-line payment granting intermediary gateway (P/G) and autonomously stores the received payment granted data in an on-line site;
an Internet of communication (IoC)-bonus gateway (B/G) which automatically calculates a bonus based on the final payment granted data received from the final payment granted data DB of the on-line site and an autonomously embedded pre-set reference of the on-line site in a state of being applied into the on-line site, and stores the calculated bonus, identifies a user, and performs an interaction with a bonus server; a user terminal device which receives calculated bonus data from the IoC-B/G; and
a communication interface device which receives an agreement request for a benefit of the bonus data received from the user terminal device and interacts with the bonus server, confirms and grants bonus providing on-line site information from the bonus server and normal bonus data, and transmits a result of the interaction again to the user terminal device as a granting result.

2. The system of claim 1, further comprising:
a communication interface module which establishes communication through a communication protocol implementing the interaction between the IoC-B/G and the bonus server.

3. The system of claim 1, wherein the on-line site includes a wired on-line site or a wireless Internet application, and, wherein the accumulation and the granting are performed without interlocking between the on-line site and the bonus server or without sharing user log information, and an accumulation granting request is interacted without interlocking between the on-line payment granting intermediary gateway (P/G) and the bonus server.

4. The system of claim 2, wherein the IoC-B/G directly communicates and interacts the autonomously calculated bonus data with the bonus server or interacts the autonomously calculated bonus data with the user terminal device in a state of being interlocked and applied into the on-line site as a bilateral communication gateway (G/W) utilizing the communication protocol, and wherein the IoC-B/G identifies whether the user joins the bonus offering company in the on-line site, and, wherein even when it is identified that the user is not a member of the bonus offering company, a bonus is accumulated in advance and granted for each non-member, same person information is automatically confirmed when the user joins and is authenticated, and then the bonus before joining is automatically integrated to the authenticated member.

5. The system of claim 1, wherein the IoC-B/G sequentially or automatically selects one or more methods of the method of directly interacting the bonus data through the bilateral Internet communication or the method of interacting the bonus data through the user terminal device or the communication interface device during the interaction with the bonus server, and, wherein the IoC-B/G sequentially or automatically selects one or more of a bonus offering company dedicated wireless Internet application, a non-dedicated wireless Internet messenger application, a short message service (SMS), and a multimedia messaging service (MMS) and interacts with the bonus server during the interaction with the bonus server through the user terminal device or the communication interface device, and, wherein the IoC-B/G applies one or more kinds of bonuses to the received final payment granted data based on a pre-set reference.

6. The system of claim 1, wherein the bonus includes a point, a mileage, an electronic coupon, an electronic stamp, a lottery, an electronic gift coupon, or an event notifying notice, and, wherein the bonus is calculated for each kind of bonus based on an autonomously pre-set reference based on the final payment granted data received by the IoC-B/G, and, wherein the IoC-B/G calculates the bonus based on the received payment granted data and transmits the calculated bonus to the bonus server, or transmits the payment granted data to the bonus server as it is without calculating the bonus, and, wherein when the bonus server receives the payment granted data through the communication interface module as it is without calculating, by the IoC-B/G, the bonus, the bonus server calculates the bonus according to a bonus calculation reference for each on-line site pre-set in the bonus server.

7. The system of claim 1, wherein the bonus server authenticates the bonus user and confirms pre-set agreement or contract contents of the on-line site after receiving the bonus data, and then grants and interacts a final bonus, and simultaneously collects, calculates, stores, interacts the bonus or processes web and application services, and, wherein in the integration of the bonus, the bonus generated through the IoC-B/G in two or more on-line sites registered in the bonus server or some on-line sites among the two or more on-line sites is integrated in a unit of each user.

8. The system of claim 1, wherein the communication interface device receives the bonus data accumulation granting request from the user terminal device and interacts the received bonus data accumulation granting request from the user terminal device with the bonus server, and interacts a result of the interaction with the bonus server to the user terminal device again.

9. The system of claim 1, wherein the IoC-B/G includes:
a data transceiving module which receives the final payment granted data of the user from the final payment granted data DB of the on-line site;
a bonus calculating module which automatically applies and calculates one or more pre-set kinds of bonuses according to a pre-set reference for the final payment granted data received by the data transceiving module;
a bonus setting module which applies one or more kinds of bonuses among the various kinds of bonuses set in the bonus calculating module according to the final payment granted data received from the data transceiving module and a pre-set bonus kind application reference; and
a bonus storing and user identifying/transceiving module which stores the bonus data automatically calculated by the bonus calculating module and then simultaneously identifies a user and transceives the user accumulation granting request in real time, and, wherein the bonus is calculated for each kind of bonus according to the reference autonomously pre-set in the IoC-B/G based on the final payment granted data received by the IoC-B/G.

10. The system of claim 9, wherein the bonus storing and user identifying/transceiving module receives the bonus accumulation granting request from the user and identifies whether the user is a member or a non-member of the bonus offering company, and, wherein the bonus storing and user identifying/transceiving module directly communicates through the Internet with the bonus server through a dedicated Internet communication module utilizing an Internet communication protocol, or communicates with the bonus server via the transmission of the bonus data to the user terminal device through a mobile communication transceiving module in real time, and, wherein the bonus storing and user identifying/transceiving module performs the interaction with one or more of the bonus offering company dedicated wireless Internet application, the non-dedicated wireless Internet messenger application, the short message service (SMS), and the multimedia messaging service (MMS).

11. A method of accumulating and granting an on-line commercial transaction bonus, which uses a system for accumulating and granting an on-line commercial transaction bonus including a final payment granted data database (DB) of an on-line site, an IoC-bonus gateway (B/G), a user terminal device, an Internet payment granting intermediary gateway (P/G), a communication interface module, a communication interface device, or a bonus server, the method comprising:
receiving, by the on-line site, final payment granted data from the P/G or autonomously confirming a receipt, such as a cash receipt and an Internet banking receipt, and storing the final payment granted data in the final payment granted data DB;
performing, by the final payment granted data DB, professional transception-interlocking with the on-line site and transmitting the final payment granted data to the IoC-B/G;
receiving, by the IoC-B/G, the payment granted data from the final payment granted data DB;
determining, by the IoC-B/G, the kind of bonus for the received payment granted data, and calculating bonus data based on a pre-set reference and storing the calculated bonus data;
interacting, by the IoC-B/G, the user identified bonus data through a communication protocol, and directly interacting with the bonus server or communicating and interacting with the user terminal device in real time;
receiving, by the user terminal device, the calculated bonus data from the IoC-B/G, and then executing, by a user, a confirmation and accumulation granting request;
receiving, by the communication interface device, the accumulation and granting request of the bonus data transmitted through a bonus offering company non-dedicated messenger application or a short message service (SMS)/multimedia messaging service (MMS) from the user terminal device and simultaneously interacting with the bonus server; and
interacting, by the bonus server, the bonus data and accumulating and granting the bonus.

12. The method of claim 11, wherein the bonus is accumulated and granted without a professional program interlocking between the on-line site and the bonus server or sharing or exchanging user log information, and the accumulation and granting request is interacted without the interlocking between the Internet payment granting intermediary gateway (P/G) and the bonus server, and, wherein the bonus is first autonomously calculated in the on-line site and the bonus is accumulated and granted by requesting a bonus granting from a bonus offering company by the user.

13. The method of claim 11, wherein the IoC-B/G directly communicates through the Internet and interacts the autonomously calculated bonus data with the bonus server or interacts the autonomously calculated bonus data with the user terminal device in a state of being interlocked and applied into the on-line site as a bilateral Internet communication gateway (G/W) utilizing the communication protocol.

14. The system of claim 11, wherein the interacting with the bonus server includes confirming and granting, by the bonus server, bonus providing on-line site company information, identified user information, and normal bonus data, and then transmitting a result of the granting to the user terminal device again.

15. The method of claim 11, wherein the interacting with the bonus server includes performing bilateral interaction through one or more of a communication and interaction available wireless Internet messenger and a short message service (SMS) and multimedia messaging service (MMS) mobile communication messengers during the interaction with the user terminal device.

16. The method of claim 11, wherein the processing of the bonus data includes authenticating a bonus user and confirming pre-set agreement or contract contents of the on-line site after receiving the bonus data, and then granting and interacting a final bonus, and simultaneously collecting, calculating, and storing the bonus and processing web and application services.

17. The method of claim 11, wherein the bonus includes a point, a mileage, an electronic coupon, an electronic stamp, a lottery, an electronic gift coupon, or an event notifying notice.

18. The method of claim 11, wherein the final payment granted data includes a payment amount, information about each payment means, a payment date and time, information about an affiliated on-line site company, a final payment granting number, or user information.

19. The method of claim 11, wherein in the integration of the bonus, the bonus generated through the IoC-B/G in two or more on-line sites registered in the bonus server or some on-line sites among the two or more on-line sites is integrated in a unit of each user.

20. A computer readable recording medium, in which a program including a command performing each operation according to the method of claim 11 is recorded.
